(19) United States
(12) Patent Application Publication
(10) Pub. No.: US 2015/0326576 A1
(43) Pub. Date: Nov. 12, 2015

(54) SECURE ASSET MANAGEMENT SYSTEM

(71) Applicant: Key Systems, Inc., Fishers, NY (US)

(72) Inventors: George H. Eckerdt, Victor, NY (US); George Mastrodonato, Rochester, NY (US)

(21) Appl. No.: 14/708,854

(22) Filed: May 11, 2015

Related U.S. Application Data
(60) Provisional application No. 61/991,703, filed on May 12, 2014.

(51) Int. Cl. H04L 29/06

(52) U.S. Cl. CPC H04L 63/0876

(57) ABSTRACT

A user can acquire a request code, submit the request code with/as a request for an access code, be granted the access code, enter the access code, and be granted access to an asset, room, or other secured item or space with which the security arrangement is used to restrict access. A user interface can include a display and a data entry device to allow the user to acquire and enter the codes. The access code can be encrypted into the request code, or the request code can trigger generation of the access code according to a predefined process.

### BACKGROUND

The present invention relates to security of assets and to management thereof. More specifically, embodiments of the invention disclosed herein pertain to selectively granting access to such assets regardless of location without a physical key.

In many instances, assets that owners and/or users wish to secure are in locations conducive to the use of keyed locks. However, in other instances, keyed locks may not be sufficient to provide levels of access and/or security that owners and/or users may desire and/or require. To provide such levels and/or layers of security, electronic locking systems have been developed that allow not only securing but also tracking and/or management of assets and/or those who use them.

### SUMMARY

According to one embodiment of the present invention, a method of remote secure access to an asset can include providing a security fixture having a unique identifier (ID) and configured to selectively secure the asset. Responsive to a stimulus, the security fixture can generate a challenge code corresponding to an access code of the security fixture. Responsive to the challenge code and the unique ID of the security fixture, authentication information can be requested, including at least a user identification (UID). The access code can be provided based on at least the challenge code and the unique ID such that the security fixture will unlock responsive to the access code.

Another embodiment of the invention disclosed herein can include a system having a security fixture with a unique identifier (ID), the security fixture being configured to generate a challenge code responsive to a stimulus, the challenge code corresponding to a unique access code. An authorization application can be configured to receive the challenge code and at least the unique ID, and to provide the unique access code responsive to at least the challenge code and the unique ID. An input device of the security fixture with which a user can enter the unique access code, the security fixture being configured to trigger at least one actuator responsive to successful entry of the unique access code corresponding to the challenge code.

An additional embodiment of the invention disclosed herein can take the form of secure asset management system including a security fixture including a unique identifier (ID), a user interface (UI), locking circuitry in electrical communication with the UI, and a locking element configured to secure an asset at a first location responsive to the locking circuitry, the first location including a respective set of coordinates, the security fixture further being configured to provide a challenge code from the locking circuitry via the UI responsive to a stimulus, the challenge code corresponding to a unique access code in response to which the locking circuitry triggers the locking element. A computing device can include an authorization application at a second location configured to receive the challenge code, the unique ID, and authentication information, and to generate an access code corresponding to the challenge code responsive to the challenge code, the unique ID, and at least a portion of the authentication information.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an embodiment of the invention disclosed herein.

FIG. 2 is a schematic flow diagram of a method according to embodiments disclosed herein.

FIG. 3 is a schematic illustration of a device incorporating aspects of embodiments of the invention disclosed herein.

FIG. 4 is a schematic illustration of a device incorporating aspects of embodiments of the invention disclosed herein.

FIG. 5 is a schematic flow diagram of a method according to embodiments disclosed herein.

### DETAILED DESCRIPTION

A security asset management system according to embodiments of the invention disclosed herein can secure an asset using electronic devices to provide layers of security and levels of access, in addition to physical barriers and/or impediments to removal of an asset. For example, an electrically-operated lock can be applied to an asset, such as a cargo container, to prevent opening of the container should an unauthorized individual attempt to do so. Another example can include a drawer embedded in a wall that can contain a secure asset, but that can only be opened by an authorized individual absent destroying portions of the wall in which the drawer is embedded. A further example can include a secure door lock in a facility that will only open to authorized individuals. Some assets may be located in environments hostile to electronics and so may require a security fixture to include weatherproofing and the like. Additionally, some environments may render power delivery to electronics in the security fixture difficult. Further, there are implementations in which an asset may be left unattended for long periods of time, such that, between the passage of time and possible changes in temperature and/or other conditions, any battery that might be included within the security fixture would be likely to discharge and/or corrode.

It should be recognized that these are but a few non-limiting examples of assets that can be secured, managed, and/or tracked with embodiments of the invention disclosed herein, and that embodiments can be used to secure, manage, and/or track assets of virtually any size and/or shape and/or degree of mobility with appropriate modification. In each of these examples, authorization can be demonstrated using an access code, or the like, which may not provide as many layers of access and/or levels of security as an owner might want. Embodiments of the invention disclosed herein can provide multiple layers of access and multiple levels of security to secured assets with challenge-response type security for assets in a wide variety of environments, including remote and/or extreme and/or hostile environments such as those described in the examples above.

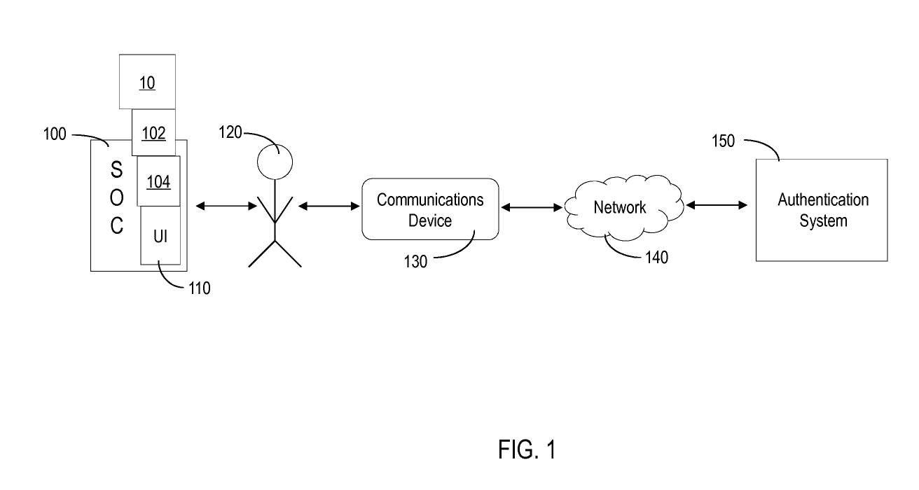

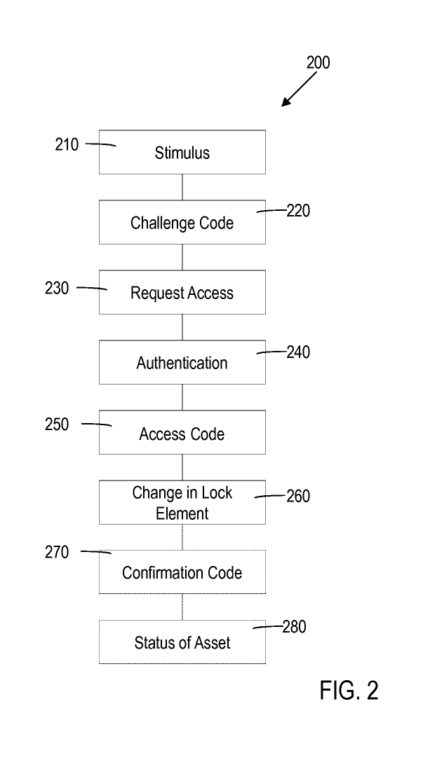

Broadly, with reference to FIGS. 1-2, embodiments can include a challenge-response method 200 designed to selectively allow access to an asset 10 at a first location, locked by, retained in, and/or otherwise secured by security fixture 100, such as with a locking mechanism 102 responsive to locking circuitry 104. Security fixture 100 can include a user interface (UI) 110 with which a user 120 can interact with security fixture 100, such as to cause security fixture 100 to unlock, release, and/or otherwise unsecure asset 10. For example, with appropriate input through UI 110, locking circuitry 104, in electrical communication with and responsive to user interface (UI) 110, can trigger locking mechanism 102 to unlock security fixture 100, as will be described below.

With continued reference to FIGS. 1 and 2, responsive to a stimulus, such as a stimulus sequence 210, locking circuitry 104 can generate a challenge code 220 and can provide the challenge code, such as to user 120, via UI 110. A stimulus in embodiments can be provided by interaction with security fixture 100, such as via UI 110, to perform and/or enter stimulus sequence 210. In embodiments, for example, user 120 can perform and/or enter stimulus sequence 210 via UI 110. Challenge code 220 can be provided by any suitable technique and/or device that can be included in UI 110, as will be explained below. Access can be requested 230, such as by user 120, by relaying authentication information, including challenge code 220, to an authorization application 150 at a second location. In addition to challenge code 220, the authentication information can include a respective user identification (UID) of user 120 and/or a unique identifier (ID) of security fixture 100, such as a serial number, respective GPS coordinates, or the like. In embodiments, the authentication information can be relayed using a communications device 130, such as a cellular or satellite telephone, a smartphone, a portable computer in communication with a computer network 140, such as the Internet, and/or any other suitable arrangement, and user 120 can relay at least some of the authentication information.

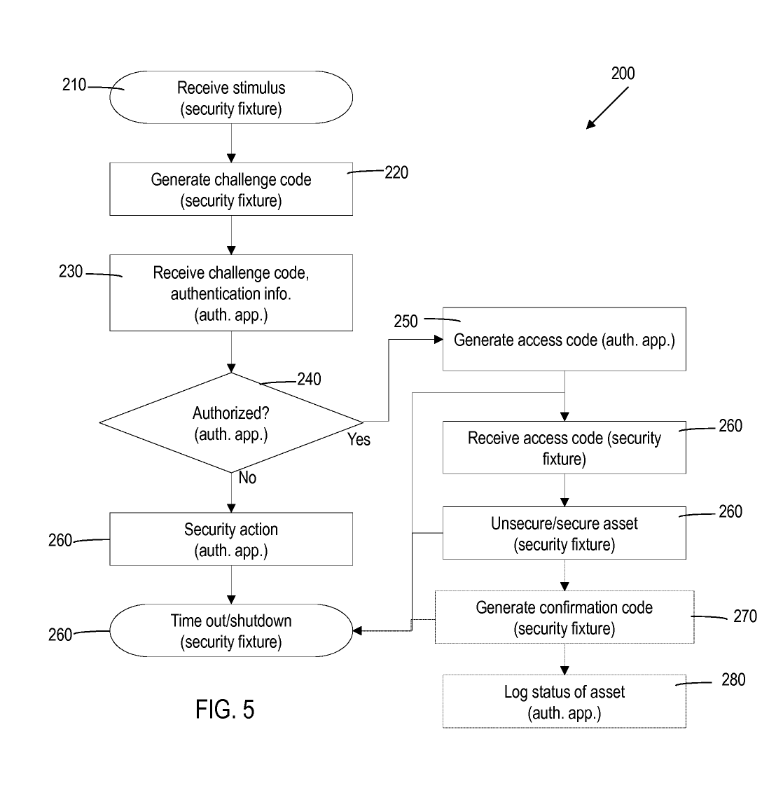

In embodiments, authentication application 150 can transmit and receive information through network 140, and can use authentication information relayed to verify that the requestor, such as user 120, has permission to access security fixture 100. For example, authentication application 150 can use at least some of the authentication information to retrieve permission information stored in a database. Responsive to authentication 240 of user 120, authentication application 150 can use challenge code 220 and the unique ID of security fixture 100, to generate an access code 250 corresponding to challenge code that can change the locked or unlocked status 260 of locking element of security fixture 100 when input through UI 110 and release the asset. A more detailed example of method 200 is shown in FIG. 5, where additional aspects of the method are shown.

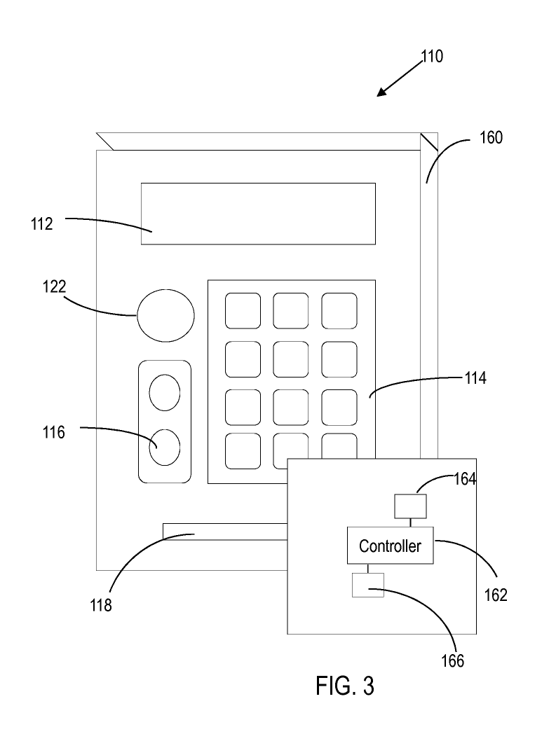

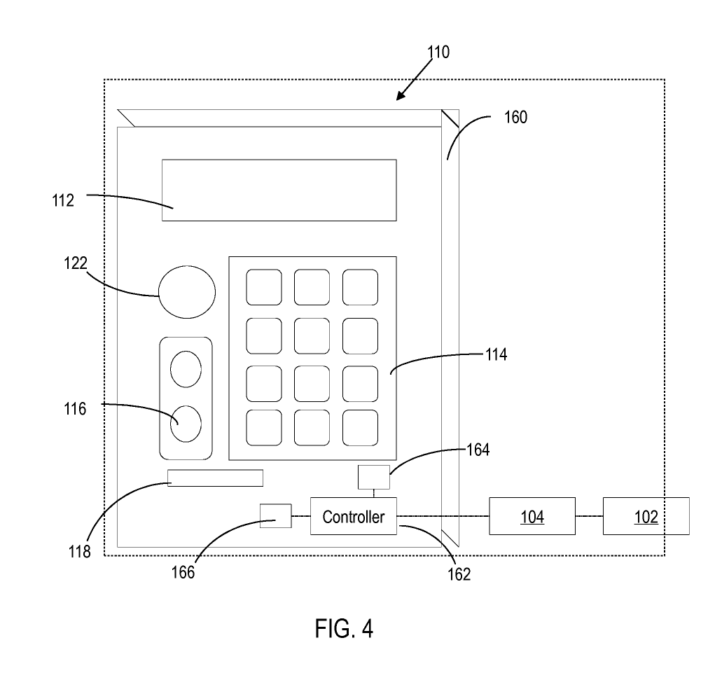

More specifically, and with reference, for example, to FIGS. 3 and 4, where FIG. 4 shows an alternative representation of the elements shown in FIG. 3, UI 110 of security fixture 100 can include a display 112, such as a visual display, and an input device 114, such as a keypad. Display 112 can take any suitable and/or desired form now known or later discovered, such as a light-emitting diode (LED) display, liquid crystal display (LCD), organic LED display, and/or any other visual display. Likewise, input device 114 can take any suitable and/or desired form now known or later discovered, such as a numeric keypad, an alphanumeric keypad, a symbolic keypad, a virtual keypad on a touch-sensitive display, and/or any other real or virtual device with which an access code can be entered. Further, while display 112 is shown as a visual display, it should be recognized that display 112 could take the form of an audio device, a tactile device, or any other device by which information can be exchanged. Similarly, input device 114 need not be a keypad or the like, but can take the form of a biometric sensor, a touchpad, a microphone, an accelerometer, a camera or other image capture device, or any other input device with which a series of characters and/or gestures and/or facial expressions and/or poses that can be used as an access code can be entered and/or any combination thereof, as well as any device or combination thereof that can read or otherwise detect an authentication device, such as a bar code scanner, a magnetic card reader, a biometric device, and/or a radio frequency-based device, such as a proximity device and/or a radio frequency identification device (RFID).

UI 110 in embodiments requires electricity to operate, yet may not be in a location allowing connection to a power source, such as utility lines or the like. While a battery could be included within security fixture 100 to provide such electricity, this is not desired in many environments, such as those in which an asset and/or security fixture 100 may be left unattended for long periods of time, in extreme conditions, and/or in conditions hostile to batteries and/or electronics. Thus, embodiments can include an external power provision, such as externally accessible electrical contacts 116 on body 160 of UI 110 and in electrical communication with a controller 162 within body 160 of UI 110. Controller 162 can distribute power to locking circuitry 104, display 112, input device 114, and/or any other component as may be required. Controller 162 can include and/or be in communication with a computing device 164 and/or a non-transitory computer readable storage medium 166. Thus, controller 162 can retrieve information from storage medium 166 and process such information with computing device 164. For example, a series of challenge codes and corresponding access codes can be stored in storage medium 166, and/or a series of access codes and an encryption function can be stored therein, and/or a challenge code generation function can be stored therein, and/or an access code generation and/or encryption function can be stored therein, and/or any other data and/or functions as may be necessary and/or desired for operation of security feature 100 can be stored therein.

In embodiments, external electrical contacts 116 can be used to provide power to security fixture 100 and UI 110. For example, an external power source can be provided, such as a battery, which can include contacts that can be connected and/or touched to contacts 116 of UI 110, such as by user 120, which can provide power to controller 162 and/or any other components of UI 110. With additional reference to FIGS. 2 and 5, providing power in such a manner can act as a stimulus to controller 162, which can be at least part of stimulus sequence 210, such that locking circuitry 104 can be configured to generate challenge code 220 responsive to the providing of power and challenge code 220 can be provided, such as via display 112. Challenge code 220 can be provided and/or displayed as long as power remains uninterrupted, particularly where display 112 is used and is a visual display, and/or until a corresponding access code 250 is successfully entered. In embodiments, a trigger other than and/or in addition to electrical contacts 116 can be provided as at least part of stimulus sequence 210, such as a switch or button or the like, an example of which is represented in FIGS. 3 and 4 as switch 122.

In some implementations according to the teachings herein, controller 162 can provide and/or display the same challenge code every time power is supplied to UI 110 until a corresponding access code is supplied, at which point the challenge code and/or access code can be removed from use and a new and/or next challenge code and/or access code can be used. In other implementations, a different challenge code can be displayed every time a stimulus is provided and/or stimulus sequence 210 is performed, such as when power is applied after being interrupted. Thus, in such implementations, power must be maintained uninterrupted until a corresponding access code is successfully entered, at which point the challenge code and/or access code can be removed from use, while any challenge code and/or access code not successfully entered before power is interrupted and/or an entry period elapses can be reused or also removed from use as may be desired and/or appropriate. In embodiments, the challenge code can remain constant and can correspond to many different access codes, and/or any other scheme can be employed as may be desired and/or appropriate.

Challenge code 220 once provided, such as via display 112, can be provided and/or relayed to authorization application 150, which can be configured to receive challenge code 220. In addition, authorization application 150 can be configured to receive the unique ID 118 corresponding to a respective security fixture 100, though in embodiments a particular security fixture 100 can be identified by challenge code 220 itself. Further, authorization application 150 can be configured to receive and/or request authentication information, such as UID and/or a shared secret. For example, a shared secret can be a user name and/or password, a code word, a phrase, a name, an image, an encryption key, biometric information, a sound, a musical note or series thereof, a gesture or series thereof, a facial expression or series thereof, and/or any other information that can be relayed and/or any combination thereof.

In the example shown, challenge code 220 can be a series of numbers displayed on display 112, and user 120 can relay challenge code 220, as well as any authentication information, such as a user name and password, over communication device 130, such as a cellular telephone or a satellite telephone, through network 140 to authorization application 150. Authorization application 150 can use speech recognition and/or speech generation software to interact with user 120, though in embodiments a human operator can receive and relay challenge code 220 and any authentication information from user 120 to authentication application 150, and/or a telephone keypad can be used to relay information to authorization application 150. It should be recognized that embodiments can include chording or the like, in which multiple keys or the like are activated simultaneously, to increase security and/or a potential number of codes that can be entered using a given input device.

Authentication application 150 can use challenge code 220 and/or ID of security fixture 100 and/or authentication information to provide an access code 250 corresponding to challenge code 220. In embodiments, providing access code 250 can be responsive to authentication 240 of the user's permission to access secured asset. For example, authentication application 150 can compare a provided user name and password combination with a stored user name and password combination, and if they match, this can be authentication 240 of the UID, and the user's level(s) of permissions(s) can be ascertained. If user 120 has permission to access secure asset 10, authentication application 130 can provide access code 250, such as by displaying the access code 250 on a display for a human operator or by generating speech to relay directly to user 120.

In embodiments, challenge code 220 can represent an encrypted form of access code 250 such that, given unique ID 118 of security fixture 100 and challenge code 220, authentication application 150 can decrypt challenge code 220 to provide access code 250, though it should be recognized that only challenge code 220 need be provided where unique ID 118 of security fixture 100 is included in challenge code 220 and/or where other means are used to ascertain to which security fixture 100 access is requested and/or user 120 wants to access. In other embodiments, challenge code 220 can be a seed used by authentication application 150 to generate a corresponding access code 250 based on the seed and/or the ID of security fixture 100 and/or other information. In additional embodiments, access code 250 can also be configured to expire after a certain access code time limit, wherein user 120 must start over upon failure to enter access code 250 into UI 110 within the limited time. Further, the user's authentication information can be used in generating the access code, thereby identifying the last authorized user 120 of the secure asset through the access code supplied. As should be clear to one skilled in the art, many other variations can be introduced within the scope of embodiments.

Referring back to FIG. 2 and with additional reference to FIG. 5, in embodiments, responsive to the change in the locked or unlocked status 260 of the locking element of security fixture 100, locking circuitry 104 can be configured to detect status 280 of secured asset 10 and to generate a confirmation code 270, which can be relayed to user 120 at the first location, such as through UI 110. User 120 can then relay confirmation code 270 back to authentication application 150 at the second location which can verify and/or log confirmation code 270 in a database or the like with other permission information. In embodiments, confirmation code 270 can include an encrypted and/or encoded form of at least status 280 of secured asset 10 such that, once relayed by user 120, authentication application 150 can decrypt confirmation code 270, use the decrypted information to verify status 280 of asset 10, and log status 280 of asset 10 in the database for future verifications. Further, confirmation code 270 can also include an encrypted and/or encoded form of the user's authentication information and position information about the secured asset at the first location, such that authentication application 150 can decrypt confirmation code 270 and use the decrypted information to verify that the secured asset has been returned to the appropriate position by the appropriate user 120. For example, where asset 10 includes a cabinet with at least one secured object and at least two locations that can be occupied by the at least one secured object, position information can include a location in which a secured object has been place. A cabinet could include a key box, and the at least one secured object could be a key, such that position information can include which position a key occupies, though it should be clear that other types of cabinets and/or secured objects can be used within the scope of embodiments of the invention disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of remote secure access to an asset, comprising:
providing a security fixture having a unique identifier (ID) and configured to selectively secure the asset;
responsive to a stimulus, generating, with the security fixture, a challenge code corresponding to an access code of the security fixture;
responsive to the challenge code and the unique ID of the security fixture, requesting authentication information including at least a user identification (UID); and
providing the access code based on at least the challenge code and the unique ID such that the security fixture will unlock responsive to the access code.

2. The method of claim 1, further comprising providing power to the security fixture from an external, portable power source.

3. The method of claim 2, wherein the stimulus includes the providing of the power.

4. The method of claim 2, wherein the providing of the power includes connecting the external, portable power source to at least one externally accessible electrical contact of the security fixture.

5. The method of claim 2, wherein the generating of the challenge code includes using circuitry of the security fixture responsive to the providing of the power.

6. The method of claim 2, wherein the challenge code changes with each providing of the power.

7. The method of claim 1, further comprising changing the challenge code responsive to receipt of the access code.

8. The method of claim 1, further comprising requesting authentication information responsive to receiving the challenge code and the providing of the access code is further responsive to a correlation between the UID and the authentication information.

9. The method of claim 1, further comprising providing a confirmation code with the security fixture after entry of the access code, and receiving with the authorization application at least the confirmation code.

10. The method of claim 9, further comprising logging the status of the secured asset by:
encrypting, with the security fixture, at least a status of the asset in the confirmation code; and
decrypting, with the authentication application, the confirmation code to obtain the at least a status of the asset.

11. The method of claim 9, wherein the confirmation code includes a status selected from the group consisting of:
an indication that the asset is present at the first location;
an indication that the asset is not present at the first location; and
a position of the asset at the first location.

12. A system comprising:
a security fixture with a unique identifier (ID), the security fixture being configured to generate a challenge code responsive to a stimulus, the challenge code corresponding to a unique access code;
an authorization application configured to receive the challenge code and at least the unique ID, and to provide the unique access code responsive to at least the challenge code and the unique ID; and
an input device of the security fixture with which a user can enter the unique access code, the security fixture being configured to trigger at least one actuator responsive to successful entry of the unique access code corresponding to the challenge code.

13. The system of claim 12, wherein the secure fixture includes a display and the security fixture is configured to display the challenge code on the display.

14. The system of claim 12, wherein the security fixture includes at least one externally accessible electrical contact and the stimulus includes providing power to the security fixture via the electrical contacts.

15. The system of claim 12, wherein the authorization application is further configured to receive authentication information and to provide the unique access code responsive to the authentication information being provided.

16. The system of claim 15, wherein the authentication information includes at least one of a customer number, a user name, a password, and location coordinates of the security fixture.

17. The system of claim 15, wherein the challenge code is an encrypted form of the access code and the authorization application is configured to:
verify that a requester has permission to access the security fixture by comparing at least some of the authentication information to permission information stored in a database;
decrypt the challenge code to determine the access code; and
provide the determined access code to the requester responsive to verification that the requester has permission to access the security fixture.

18. The system of claim 17, wherein the decrypting of the challenge code is responsive to at least the unique ID of the security fixture.

19. A secure asset management system comprising:
a security fixture including a unique identifier (ID), a user interface (UI), locking circuitry in electrical communication with the UI, and a locking element configured to secure an asset at a first location responsive to the locking circuitry, the first location including a respective set of coordinates, the security fixture further being configured to provide a challenge code from the locking circuitry via the UI responsive to a stimulus, the challenge code corresponding to a unique access code in response to which the locking circuitry triggers the locking element, wherein the locking element places the lock in a locked state in a first position and places the lock in an unlocked state in a second position, and triggering the locking element comprises moving the locking element from the first position to the second position; and
a computing device including an authorization application at a second location configured to receive the challenge code, the unique ID, and authentication information, and to generate an access code corresponding to the challenge code responsive to the challenge code, the unique ID, and at least a portion of the authentication information.

20. The system of claim 19, wherein the challenge code includes symbols and the UI includes a display on which symbols can be formed.

21. The system of claim 19, wherein the access code includes symbols and the UI includes an input device with which symbols can be provided to the locking circuitry.
